(19) United States
(12) Patent Application Publication
(10) Pub. No.: US 2020/0040622 A1
(43) Pub. Date: Feb. 6, 2020

(54) CLOSURE SYSTEM FOR MOTOR VEHICLE HAVING VEHICLE STRIKER WITH VIBRATION DAMPENING ASSEMBLY

(71) Applicant: Magna BOCO GmbH, Wuppertal (DE)

(72) Inventor: Michael DIGEL, Wuppertal (DE)

(21) Appl. No.: 16/525,728

(22) Filed: Jul. 30, 2019

Related U.S. Application Data
(60) Provisional application No. 62/714,581, filed on Aug. 3, 2018.

(51) Int. Cl. E05B 85/04; B60J 5/10; E05B 77/36

(52) U.S. Cl. CPC E05B 85/04; E05B 77/36; B60J 5/107

(57) ABSTRACT

A striker assembly for a vehicle closure panel includes a striker plate extending between first and second ends with a striker fixed to the striker plate adjacent the first end. A base plate is pivotally coupled to the striker plate between the first and second ends. A dampener assembly is operably fixed to the striker plate and the base plate adjacent the second end of the striker plate. The dampener assembly provides dampening pivotal movement of the striker plate relative to the base plate, with the dampener assembly being resistant to effects from environmental thermal conditions, while having a variable dampening characteristic curve.

### CROSS-REFERENCE TO RELATED APPLICATION

This application claims the benefit of U.S. Provisional Application Ser. No. 62/714,581, filed Aug. 3, 2018, which is incorporated herein by way of reference in its entirety.

### FIELD

The present disclosure relates to latch assemblies for motor vehicles, and more particularly, to dampened striker assemblies for motor vehicle latch assemblies.

### BACKGROUND

Known closure latch assemblies for automotive vehicles include a latch assembly and a striker assembly respectively carried by a closure panel to be opened and closed and adjacent vehicle body structure, or vice versa. The striker assemblies have a U-shaped striker fixed to a metal support plate, which in turn is fixed to one of a metal support panel of the vehicle closure panel or vehicle body structure.

During use of a motor vehicle vibrations are generated, such as, by way of example, via the vehicle engine and gear train and by moving vehicle components, including closure panels, wherein the vibrations can travel throughout the vehicle. The vibrations can result in the production of noise that can be audible and inaudible. The inaudible noise is typically a low frequency noise that can be sensed via feel. Both the audible and inaudible noises are typically undesirable to vehicle occupants.

Efforts to inhibit the generation and transmission of vibrations include the use of rubber mount pads disposed between adjoined members, e.g. striker assembly and mounting surface, to isolate the members from one another to inhibit the transfer of vibration therebetween. Although rubber mount pads are helpful, they have limitations. For example, rubber mount pads have thermal limitations that can impact their ability to function as desired, including in high heat or cold thermal conditions, and further, they have a fixed dampening characteristic curve, thereby limiting their functionality. Accordingly, further advancements are desired.

### SUMMARY

This section provides a general summary of the present disclosure and is not a comprehensive disclosure of its full scope or all of its features, aspects and objectives.

In accordance with one aspect of the disclosure, a striker assembly for a closure panel of a motor vehicle is provided, wherein the striker assembly includes a dampened striker that overcomes drawbacks of known striker assemblies.

In accordance with one aspect of the disclosure, a dampening characteristic of the dampened striker is selectively adjustable.

In accordance with another aspect of the disclosure, the striker assembly includes a striker plate having opposite sides extending between first and second ends. A striker is fixed to the striker plate adjacent the first end. A base plate is pivotally coupled to the striker plate between the first and second ends. A dampener assembly is fixed to the striker plate and the base plate adjacent the second end of the striker plate, wherein the dampener assembly provides dampening pivotal movement of the striker plate relative to the base plate.

In accordance with another aspect of the disclosure, the dampener assembly includes a support member fixed against movement relative to one of the striker plate and the base plate and at least one dampener member disposed about the support member in dampening relation with the other of the striker plate and the base plate.

In accordance with another aspect of the disclosure, the at least one dampener member can be fixed in abutment with the striker plate.

In accordance with another aspect of the disclosure, the at least one dampener member can include at least one dampener member disposed on opposite sides of the striker plate.

In accordance with another aspect of the disclosure, the at least one dampener member can include a plurality of dampener members disposed on opposite sides of the striker plate.

In accordance with another aspect of the disclosure, the at least one dampener member can be provided as a Belleville washer.

In accordance with another aspect of the disclosure, an adjustment member can be disposed about the support member, with the adjustment member being selectively moveable along the support member to change a dampening characteristic of the at least one dampener member.

In accordance with another aspect of the disclosure, the support member can be provided having external threads and the adjustment member can be provided as a nut having internal threads in threaded engagement with the external threads.

In accordance with another aspect of the disclosure, the support member can be provided having an annular flange fixed thereto and a washer can be disposed in a clearance fit about a shank of the support member wherein the at least one dampener member is disposed between the annular flange and the washer.

In accordance with another aspect of the disclosure, the at least one dampener member can include a plurality of dampener members disposed between the annular flange and the washer.

In accordance with another aspect of the disclosure, at least one of the plurality of dampener members can be disposed on a first side of the striker plate between the first side and the washer and at least one of the plurality of dampener members cab be disposed on a second side of the striker plate, opposite the first side, between the annular flange and the second side.

In accordance with another aspect of the disclosure, a plurality of the dampener members can be disposed between the first side and the washer and a plurality of the dampener members can be disposed between the annular flange and the second side.

In accordance with another aspect of the disclosure, a method for inhibiting the generation and transmission of vibration through a striker assembly of a motor vehicle closure panel is provided. The method includes a step of providing a striker plate having opposite sides extending between first and second ends. Further, a step of fixing a striker to the striker plate adjacent the second end. Further, a step of pivotally coupling a base plate to the striker plate between the first end and the second end. Further yet, a step of fixing a dampener assembly to the striker plate and the base plate adjacent the first end of the striker plate and configuring the dampener assembly to dampen pivotal movement of the striker plate relative to the base plate.

In accordance with another aspect of the disclosure, the method can further include a step of fixing a support member against movement relative to one of the striker plate and the base plate and disposing at least one dampener member about the support member in dampening relation with the other of the striker plate and the base plate.

In accordance with another aspect of the disclosure, the method can further include a step of fixing the support member against movement relative to the base plate and disposing the at least one dampener member in dampening relation with the striker plate.

In accordance with another aspect of the disclosure, the method can further include a step of disposing at least one dampener member on opposite sides of the striker plate.

In accordance with another aspect of the disclosure, the method can further include a step of fixing an annular flange to the support member, disposing a washer in a clearance fit about the support member, and disposing the at least one dampener member between the annular flange and the washer.

In accordance with another aspect of the disclosure, the method can further include a step of disposing at least one dampener member on a first side of the striker plate between the first side of the striker plate and the washer, and disposing at least one dampener member on a second side of the striker plate, opposite the first side of the striker plate, between the annular flange and the second side of the striker plate.

In accordance with another aspect of the disclosure, the method can further include a step of disposing a plurality of dampener members between the first side of the striker plate and the washer and disposing a plurality of dampener members between the annular flange and the second side of the striker plate.

In accordance with another aspect of the disclosure, the method can further include a step of disposing an adjustment member about the support member and moving the adjustment member along the support member to adjust a dampening characteristic of the at least one dampener member.

In accordance with another aspect of the disclosure, the method can further include a step of providing the support member having external threads and providing the adjustment member as a nut having internal threads in threaded engagement with the external threads.

In accordance with another aspect of the disclosure, the method can further include a step of providing the at least one dampener member as a Belleville washer.

### BRIEF DESCRIPTION OF THE DRAWINGS

These and other aspects, features and advantages of the present disclosure will be readily appreciated, as the same becomes better understood by reference to the following detailed description when considered in connection with the accompanying drawings wherein:

FIG. 1 is a perspective view of a motor vehicle having a striker assembly in accordance with the disclosure configured for latched coupling with a latch assembly;

FIG. 2 is a front perspective view of a striker assembly in accordance with an aspect of the disclosure shown coupled with a latch assembly of the vehicle of FIG. 1;

FIG. 2A is a rear perspective view of the striker assembly of FIG. 2 shown coupled with the latch assembly of the vehicle of FIG. 1;

FIG. 2B is a cross-sectional view of the striker assembly and latch assembly of FIG. 2 taken generally along line 2B-2B of FIG. 2;

FIG. 3 is a perspective view of the striker assembly of FIG. 2;

FIG. 3A is a top view of the striker assembly of FIG. 3;

FIG. 3B is a side view of the striker assembly of FIG. 3;

FIG. 3C is a cross-sectional view taken generally along line 3C-3C of FIG. 3A;

FIG. 3D is a cross-sectional view taken generally along line 3D-3D of FIG. 3B;

FIG. 3E is a cross-sectional view taken generally along line 3E-3E of FIG. 3B;

FIG. 3F is an enlarged view of the encircled area 3F of FIG. 3E;

FIG. 3G is a characteristic curve of the striker assembly of FIG. 2;

FIG. 4 is an exploded view of the striker assembly of FIG. 2;

FIGS. 5A-50 illustrate assembly steps used in accordance with an aspect of the disclosure to construct the striker assembly of FIG. 2;

FIG. 6 is a perspective view of a striker assembly in accordance with another aspect of the disclosure;

FIG. 6A is a top view of the striker assembly of FIG. 6;

FIG. 6B is a side view of the striker assembly of FIG. 6;

FIG. 6C is a cross-sectional view taken generally along line 6C-6C of FIG. 6A;

FIG. 6D is a cross-sectional view taken generally along line 6D-6D of FIG. 6B;

FIG. 6E is a cross-sectional view taken generally along line 6E-6E of FIG. 6B;

FIG. 6F is an enlarged view of the encircled area 6F of FIG. 6E;

FIG. 6G is a characteristic curve of the striker assembly of FIG. 6;

FIG. 7 is an exploded view of the striker assembly of FIG. 6; and

FIGS. 8A and 8B illustrate a flow diagram of a method for inhibiting the generation and transmission of vibration through a striker assembly of a motor vehicle closure panel in accordance with another aspect of the disclosure.

### DETAILED DESCRIPTION OF EXAMPLE EMBODIMENTS

In general, example embodiments of latch assemblies and striker assemblies therefor constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

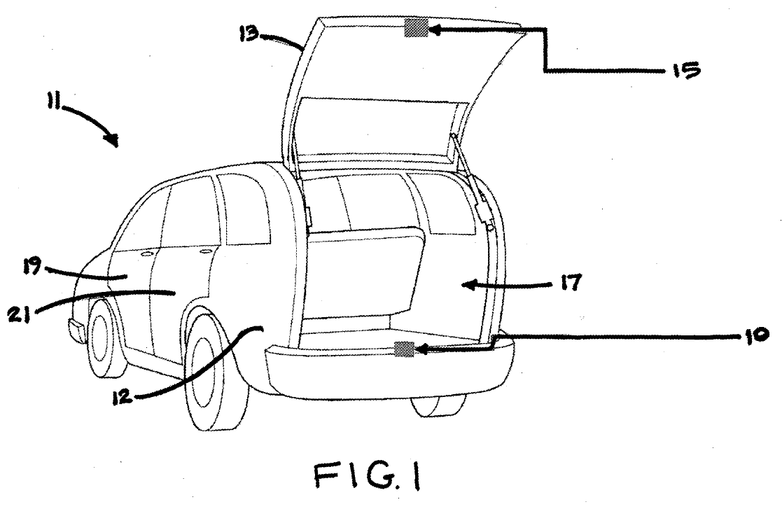

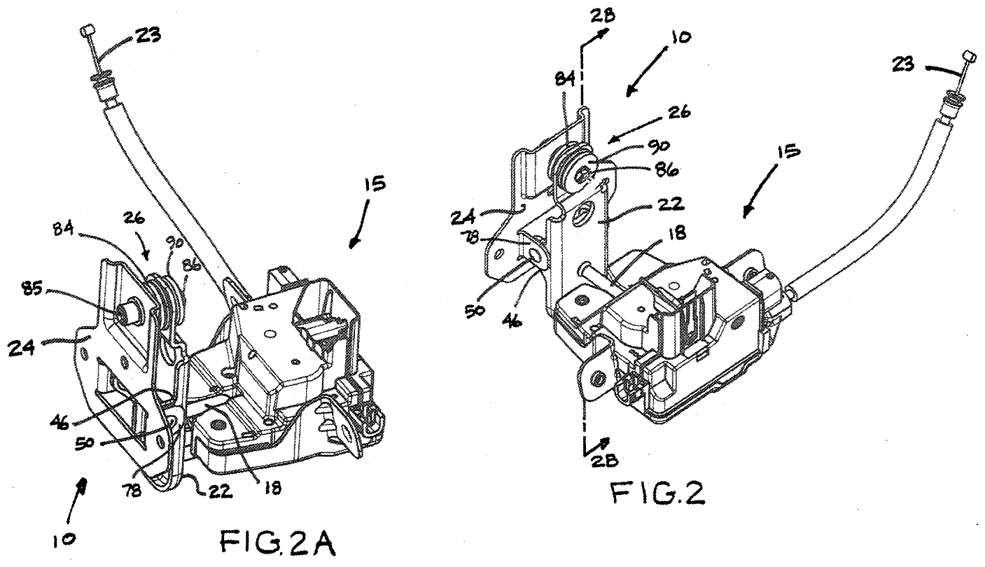

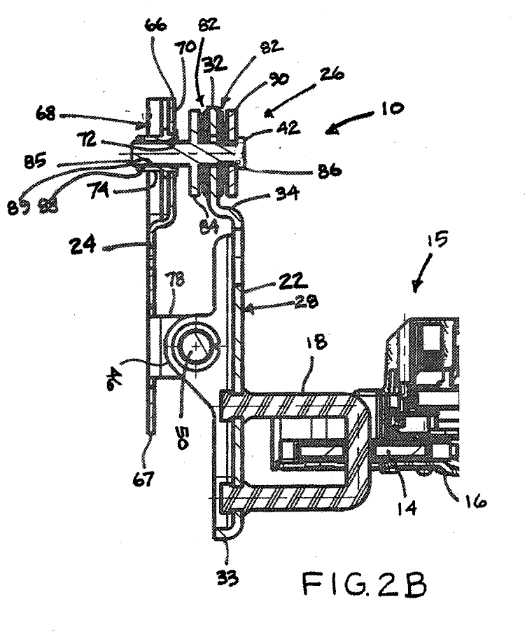

Reference is made to FIG. 1, which shows a motor vehicle 11 that has a closure panel, such as a rear hatch 13, by way of example and without limitation, to which there is a latch assembly 15 attached, wherein the latch assembly 15 is configured for latched/unlatched coupling with a dampening striker assembly, referred to hereafter as striker assembly 10, constructed in accordance with an aspect of the disclosure. The striker assembly 10 is shown mounted on a body 12 of the motor vehicle 11, while latch assembly 15 is shown mounted to the rear hatch 13, though it is to be understood that the latch assembly 15 and striker assembly 10 could be reversed in orientation, with the striker assembly 10 being mounted to the rear hatch 13 and the latch assembly 15 being mounted to the body 12. Upon selective actuation of latch assembly 15 via selective actuation of cable/rod 23, the rear hatch 13 can be opened to allow access to a stowage space, often referred to as trunk 17. Referring to FIG. 2B, the latch assembly 15 includes a ratchet 14 that is pivotably connected to a housing 16 and is movable between a closed position and an open position in response to selective actuation of latch assembly 15. The ratchet 14 prevents the withdrawal of a striker 18 of the striker assembly 10 when in the closed position and allows withdrawal of the striker 18 when in the open position. Striker assembly 10 is constructed, as discussed in more detail below, to decouple striker 18 from the member to which striker assembly 10 is mounted in such manner that the decoupling is resistant to thermal conditions, thereby being generally unaffected by fluctuating environmental temperatures, while also being positionally adjustable and/or having a dampening characteristic curve that is adjustable. Although striker assembly 10 is discussed in relation to rear hatch 13, it is contemplated herein that striker assembly 10 could be used with any other closure panel of vehicle 11, such as front and/or rear passenger doors 19, 21, by way of example and without limitation.

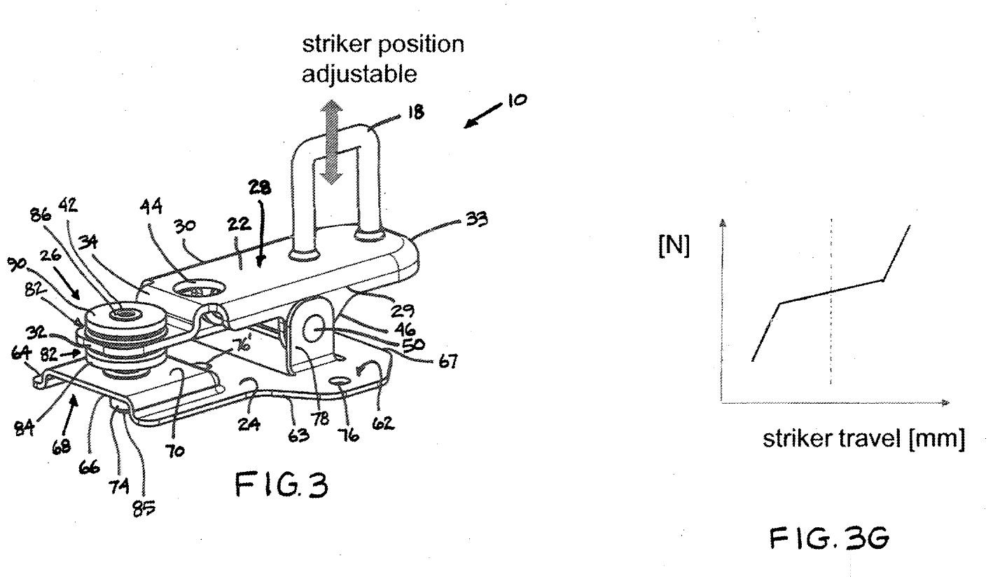

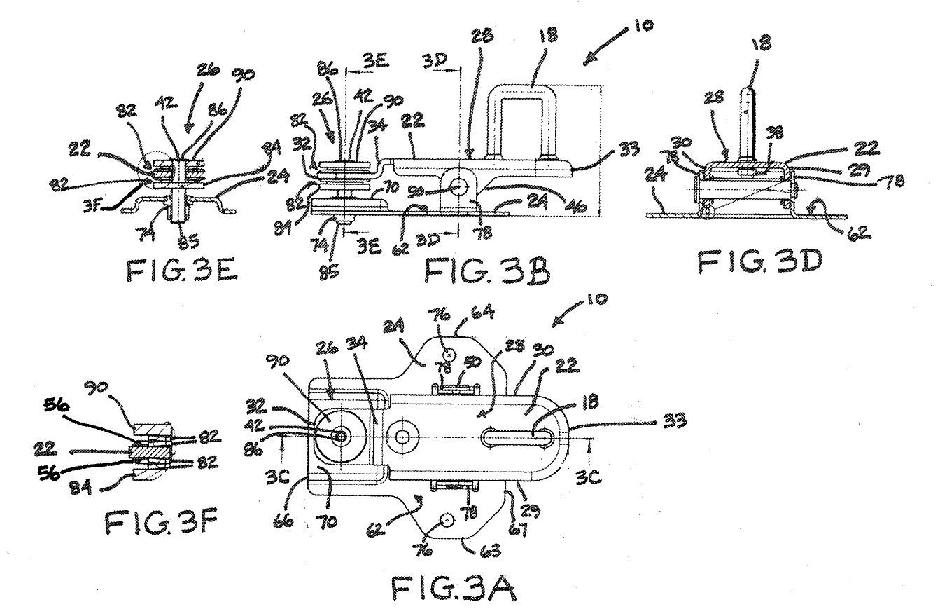

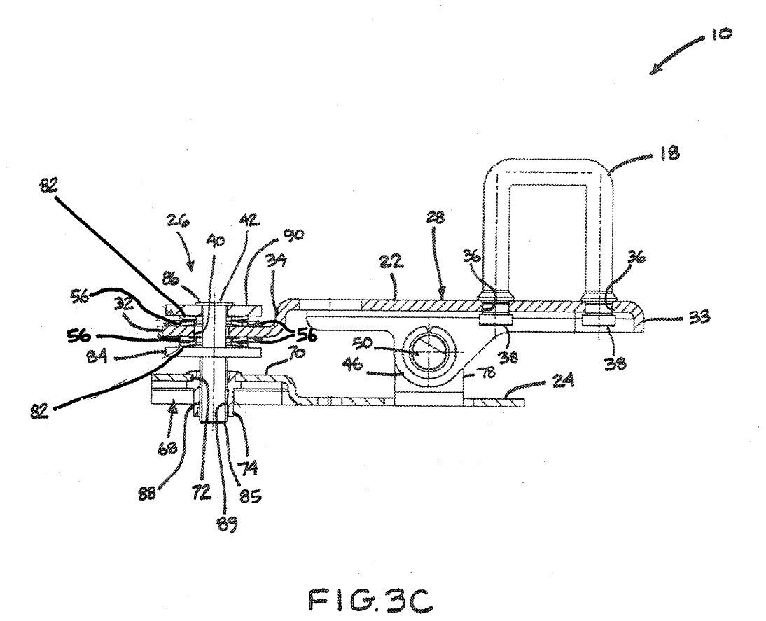

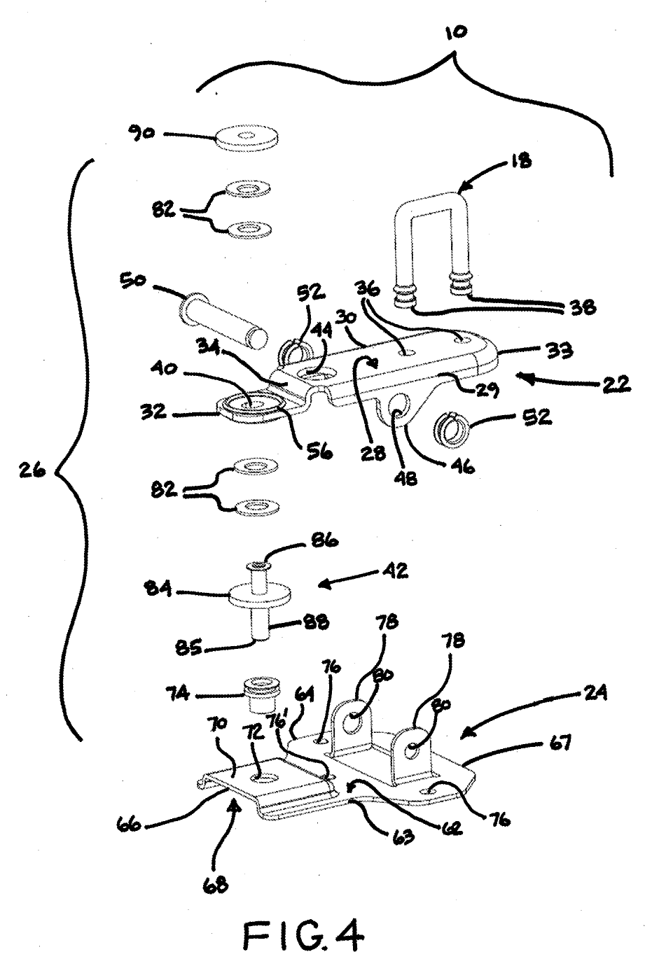

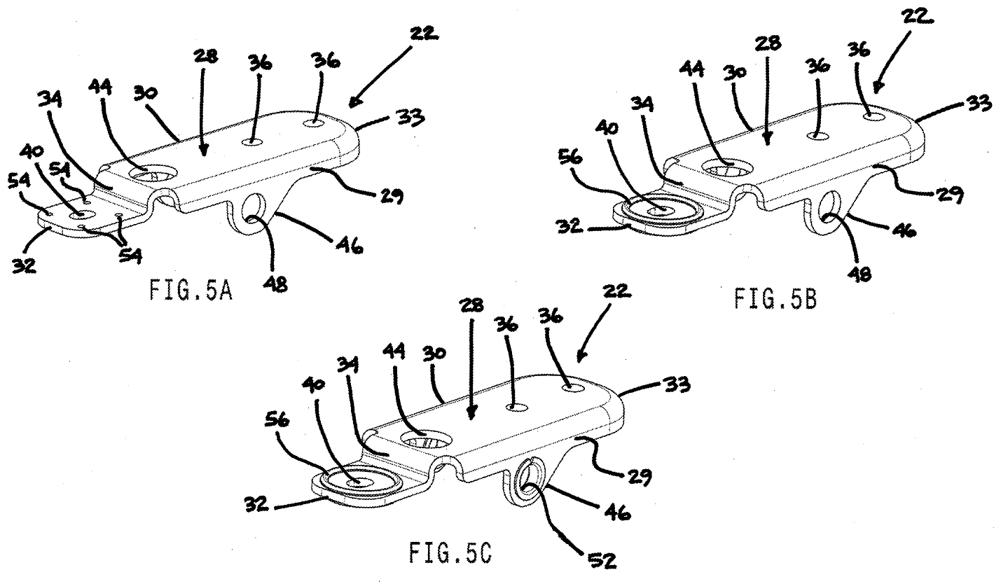

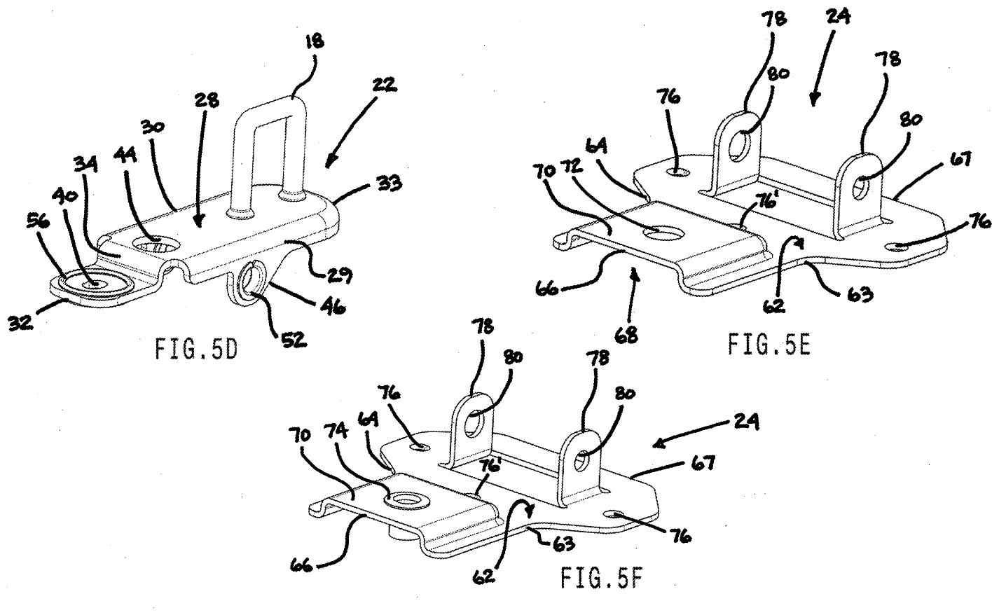

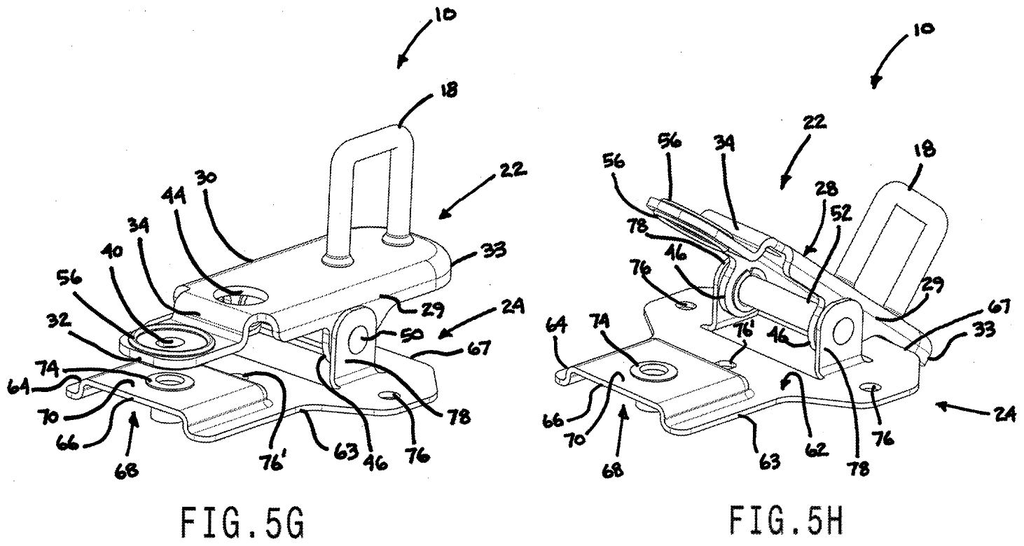

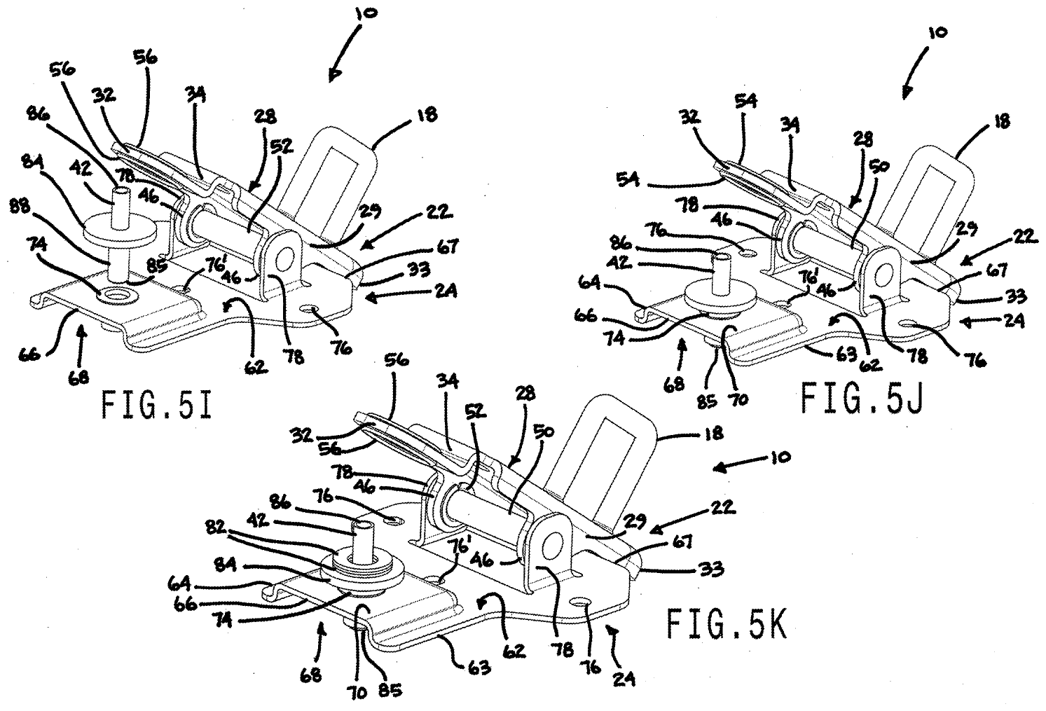

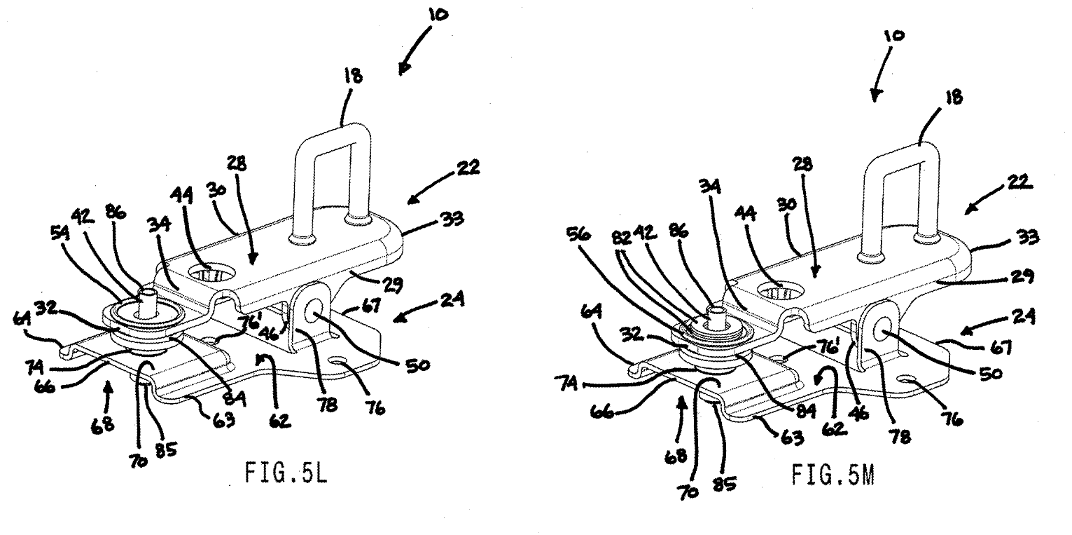

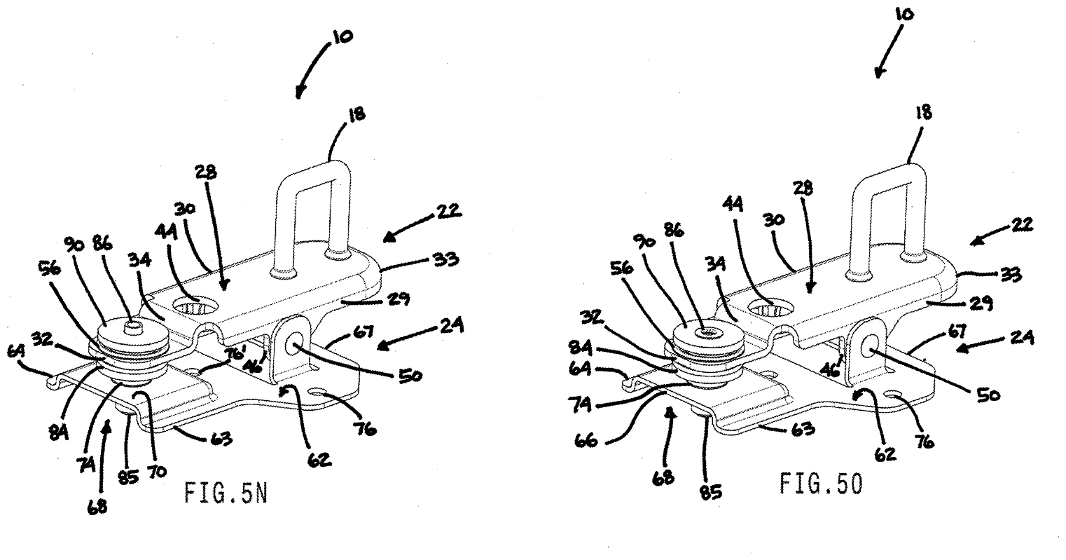

As best shown in FIGS. 3-3E and FIG. 4, the striker assembly 10 includes a striker plate 22, with striker 18 fixed thereto, a base plate 24, and a vibration dampening assembly, referred to hereafter as dampener assembly 26. The striker plate 22 has a generally planar surface 28 with opposite sides 29, 30 extending lengthwise between opposite respective first and second ends 32, 33. The generally planar surface 28 is shown as having a stepped region provided by a step 34 extending laterally between the opposite sides 29, 30 proximate the first end 32, such that the opposite ends 32, 33 are slightly offset from one another. To facilitate fixation of the striker 18 adjacent end 33 of striker plate 22, striker plate 22 has at least one, and shown as a pair of striker openings 36 configured for fixed attachment of opposite ends 38 of striker 18 therein. Fixation of ends 38 of striker 18 within striker openings 36 can be performed via any desired fixation mechanism, including, by way of example and without limitation, swaging, welding, adhesive, or combination thereof. To facilitate fixation of the dampener assembly 26 to striker plate 22, striker plate 22 has an opening 40 configured for receipt of a support member, also referred to as fastener or fixation member 42, of dampener assembly 26 therethrough in a clearance fit, wherein fixation member 42 can be provided as an elongate stud, rivet, bolt or the like, as desired for the intended use/function. An access opening 44 can be provided adjacent step 34 for ready access to a fastener (not show) used to fix base plate 24 to vehicle body 12. Striker plate 22 further includes a pair of bosses 46 depending from the opposite sides 29, 30, with each of the bosses 46 having through openings 48 to facilitate pivotal attachment of striker plate 22 to base plate 24, such as via an axle 50, by way of example and without limitation. It is to be recognized that axle 50 can be provided as a single elongate axle, as shown, or individual axles could be used for each boss 46, as desired. Axles could also take the form of rivets or otherwise, as desired. To facilitate forming a snug, such as line-to-line fit of axle 50 within through openings 48, and to facilitate smooth, dampened pivoting movement of striker plate 22 relative to base plate 24, annular liners or bushings 52 can be disposed within through openings 48, wherein bushings 52 can be formed of any desired bearing grade metal or polymeric material. To facilitate attachment/bonding of a dampener material, such as rubber or other suitable polymeric material, to striker plate 22 about opening 40, one or a plurality of dimples or through openings 54 (FIG. 5A) can be formed about opening 40, such that the dampening material can be bonded or molded to extend into or through the through openings 54 to provide annular dampeners 56 (FIGS. 5B-5D and 5G-5N) about opening 40 on opposite sides of striker plate 22.

The base plate 24 has a generally planar surface 62 with opposite sides 63, 64 extending lengthwise between opposite respective first and second ends 66, 67. The generally planar surface 62 is shown as having a recessed pocket 68 formed by an upstanding shelf, also referred to as plateau 70, with plateau 70 being elevated between the opposite sides 63, 64 proximate, and shown immediately adjacent the first end 66. The pocket 68 is formed having a depth sufficient for receipt of an end of fixation member 42 therein, such that the end of fixation member 42 does not interfere with a surface of vehicle body 12 to which base plate 24 is mounted. To facilitate fixation of the dampener assembly 26 to base plate 24, base plate 24 has an opening 72 (FIGS. 4 and 5E) configured for receipt of a fixation member, such as an internally threaded nut, shown as a rivet-type nut, referred to hereafter as rivet nut 74. Rivet nut 74 is configured for threaded fixation of and end of fixation member (bolt) 42 therein. It is to be recognized that pocket 68 has a depth sufficient for receipt of an end of rivet nut 74 therein, such that rivet nut 74 does not interfere with a surface of vehicle body 12 to which base plate 24 is mounted. A plurality of fastener openings 76 are form through base plate 24 to facilitate fixing base plate 24, and thus, the striker assembly 10 to the vehicle body 12. One of the fastener openings 76′ is shown aligned with access opening 44 in striker plate 22, such that a fastener (not shown) disposed within fastener opening 76′ can be accessed via an appropriate tool extended through access opening 44. Base plate 24 further includes a pair of flanges 78 upstanding from planar surface 62, with each of the flanges 78 having through openings 80 configured to register with the through openings 48 of the bosses 46 for receipt of axle 50 therethrough to facilitate pivotal attachment of striker plate 22 to base plate 24 via axle 50. Flanges 78 are configured for close receipt (line-to-line or slightly loose, preferably) proximate bosses 46, shown as being disposed laterally outwardly from bosses 46, by way of example and without limitation.

The dampener assembly 26 provides dampened pivotal movement of the striker plate 22 relative to the base plate 24. Dampener assembly 26 includes the fixation member 42, wherein the fixation member 42 is configured to be fixed against movement relative to one of the striker plate 22 and the base plate 24, shown, by way of example and without limitation, as being fixed against relative movement to base plate 24. Dampener assembly 26 further includes at least one elastically resilient dampener member, referred to hereafter as dampener member 82, disposed about the fixation member 42 in fixed abutment with the other of the striker plate 22 and the base plate 24, shown, by way of example and without limitation, as being fixed against relative movement to striker plate 22 in abutment with striker plate 22. Vibrational frequencies as generated for example by the effect of air movement over the surface of the closure panel e.g. passenger doors 19, 21, rear hatch 13, may be dampened and/or suppressed by the dampener assembly 26 and for example by the at one dampener member 82 to prevent such vibrations from propagating through the base plate 24 and to the vehicle body 12 where it can be perceived as noise or disturbance by the passengers. Also, the movement of the striker 18 and therefore the movement of the passenger doors 19, 21, rear hatch 13 can be dampened and controlled by the dampener assembly 26 (e.g. see FIGS. 3G and 3G illustrating the dampening characteristics applied to the striker 18 based on its movement due to for example wind or road vibrations, and notably the dampening effect on the striker 18 increases, as illustrated by the change in slopes of the characteristic curves, as the striker 18 moves away (striker travel in millimeters) from a neutral rest position indicated by the dotted line of FIGS. 3G and 3G). The at least one dampener member 82 is shown as a plurality of dampener members 82, such as spring metal washers, including wavy washers or cup washers, also known as Belleville washers, by way of example and without limitation. It is to be understood that other types of resilient dampener members 82 could be used, including rubber or elastomeric washers of a desired durometer, for example. At least one of the plurality of dampener members 82 can be disposed on each of the opposite sides of the striker plate 22, such that at least one dampener 82 is disposed on opposite sides of the striker plate 22, wherein an exemplary embodiment is shown having a pair of dampener members 82 on each side of the striker plate 22, such that dampener members 82 are arranged in dampening relation with the striker plate 22. Each pair of dampener members 82 is shown flared away from one another, such that an inner periphery of each one of the pairs of dampener members 82 abuts one another, while an outer periphery of each one of the pairs of dampener members 82 is spaced from one another, thereby allowing the pairs of dampener members 82 to deflect into flattened or substantially flattened (less than completely flattened) relation with one another under a predetermined load sufficient to overcome the spring bias imparted by the dampener members 82. The outer peripheries of the dampener members 82 are shown having a diameter slightly less than a diameter of the annular dampeners 56, such that if the dampener members 82 become flattened sufficiently, the dampeners 56 can further dampen the striker assembly 10, as discussed further below.

The fixation member 42 can be provided having an annular flange 84 intermediate (between) opposite first and second ends 85, 86, wherein the first end 85 can be configured for fixed attachment to base plate 24, such as via external threads 88 configured for threaded engagement with internal threads 89 of rivet nut 74. With the first end 85 fixed to the rivet nut 74, the annular flange 84 can be located beneath a bottom side of the planar surface 28 with a shank of the fixation member 42 extending upwardly from the annular flange 84 through the opening 40 above an upper side of the planar surface 28. To facilitate maintaining the dampener assembly 26 in an assembled state, a washer 90 can be disposed over the second end 86 in a clearance fit about the shank of the fixation member 42 and then the second end 86 can be flared radially outwardly, such as in a swaging process, by way of example and without limitation, to capture the washer 90 in fixed relation about the shank of the fixation member 42. It is to be recognized that the washer 90 could be otherwise attached to the fixation member 42, such as via threaded engagement, welding, adhesive, or otherwise.

In an exemplary embodiment, a pair of dampener members 82 is disposed between, and in sandwiched relation with, the annular flange 84 and the bottom or lower side of the striker plate 22 and a pair of dampener members 82 is disposed between, and in sandwiched relation with, the washer 90 and the top or upper side of the striker plate 22. Accordingly, dampener members 82 are arranged in dampening relation with striker plate 22, wherein one or more of the dampeners members 22 can be arranged to directly abut striker plate 22, shown as one within a pair of dampener members 82 above and one within a pair of dampener members 82 below striker plate 22 being in direct abutment with striker plate 22. An axial distance (distance extending axially along the length of the fixation member 42) can be precisely set in assembly between an upper surface of the annular flange 84 facing the striker plate 22 and a lower surface of the washer 90 facing the striker plate 22 to provide the desired “as assembled” compressive force between the dampener members 82 to establish a precisely predetermined preload across the dampener members 82, as will be readily understood by one possessing ordinary skill in the art upon viewing the disclosure herein.

In FIGS. 5A-5N, an assembly process in accordance with an aspect of the disclosure is shown. The striker plate 22 is shown in FIG. 5A as fabricated, such as, at least in part, in a progressive stamping or forging process, by way of example and without limitation. In FIG. 5B, annular dampeners 56 are provided about opening 40, such as in a molding process, by way of example and without limitation, such that the material of the dampeners 56 can flow through the through openings 54 to facilitate fixed, reliable attachment of the dampeners 56 to the striker plate 22. It is contemplated that dampeners 56 could be preformed and subsequently fixed, such as in a bonding process, to striker plate 22. In FIG. 5C, bushings 52 are disposed within through openings 48 of bosses 46. The bushings 52 can be preformed and subsequently fit within through openings 48, or bushings 52 can be formed within through openings 48 via any suitable molding, dipping or spraying process, by way of example and without limitation. In FIG. 5D, striker 18 is fixedly attached to striker plate 22. In the exemplary embodiment, ends 38 or generally U-shaped striker 18 are disposed through striker openings 36 and then ends 38 are fixed therein, such as via a swaging, welding, adhesive, or combination thereof. The base plate 24 is shown in FIG. 5E as fabricated, such as, at least in part, in a progressive stamping or forging process, by way of example and without limitation. In FIG. 5F, rivet nut 74 is disposed and fixed within opening 72 of base plate 24. In FIG. 5G, subassembly of striker plate 22 and subassembly of base plate 24 are pivotally coupled together via axle 50. Axle 50 is disposed through axially aligned bushings 52 and through openings 80 and fixed against removal therefrom, such as via swaging and end or ends of axle 50 or via any suitable fixation mechanism. Upon pivotally fixing striker plate 22 to base plate 24, striker plate 22 and base plate 24 are free to pivot relative to one another about axle 50. In FIG. 5H, striker plate 22 is pivoted to raise first end 32 of striker plate 22 away from base plate 24 to expose rivet nut 74 and internal threads 89 thereof for insertion of fixation member 42 therein. As shown in FIG. 5I, external threads 88 adjacent first end 85 of fixation member 42 are positioned for threaded engagement with internal threads 89 of rivet nut 74, and then, as shown in FIG. 5J, fixation member 42 is threaded into fixed attachment with base plate 24. Then, as shown in FIG. 5K, at least one, and shown as a pair of dampener members 82 are disposed about a shank of fixation member 42 and onto annular flange 84. With fixation member 42 fixed to base plate 24, as shown in FIG. 5L, striker plate 22 is pivoted to dispose second end 86 of fixation member 42 through opening 40 of striker plate 22, thereby sandwiching the pair of dampener members 82 between annular flange 84 and a bottom surface of striker plate 22. Then, as shown in FIG. 5M, at least one, and shown as a pair of dampener members 82 are disposed about shank of fixation member 42 and onto an upper surface of striker plate 22. Then, as shown in FIG. 5N, washer 90 is disposed about shank of fixation member 42 onto dampener members 82, whereupon, as shown in FIG. 5O, washer 90 is fixed on fixation member 42, such as via swaging the second end 86 of fixation member 42, by way of example and without limitation, though washer 90 could be otherwise fixed to fixation member 42, such as via welding, adhesive or otherwise. It is to be recognized that the preload established across dampener member(s) 82 can be set as desired while fixing washer 90 in compressed relation against dampener members 82. With striker assembly 10 assembled, striker assembly 10 can be fixed to vehicle body 12 via any suitable fasteners, such as via threaded bolts or screws disposed through fastener openings 76, 76′.

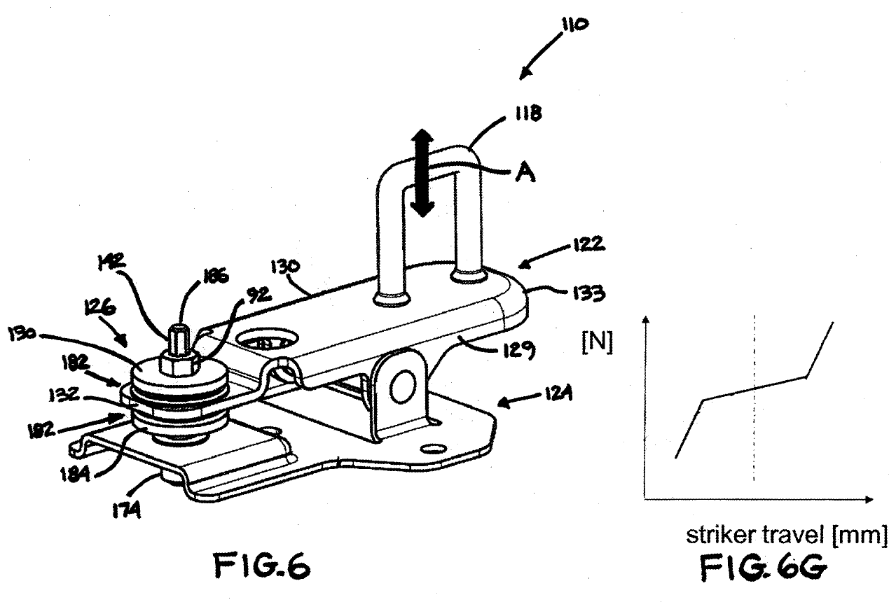

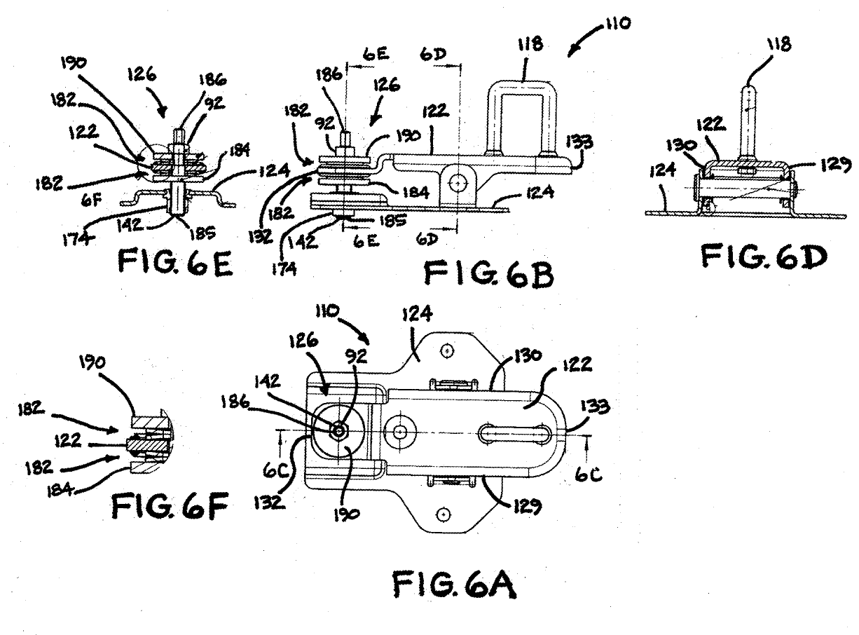

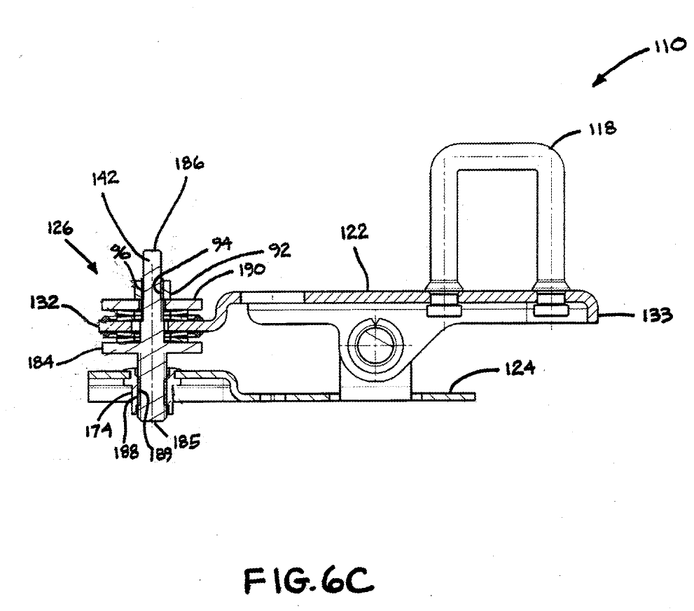

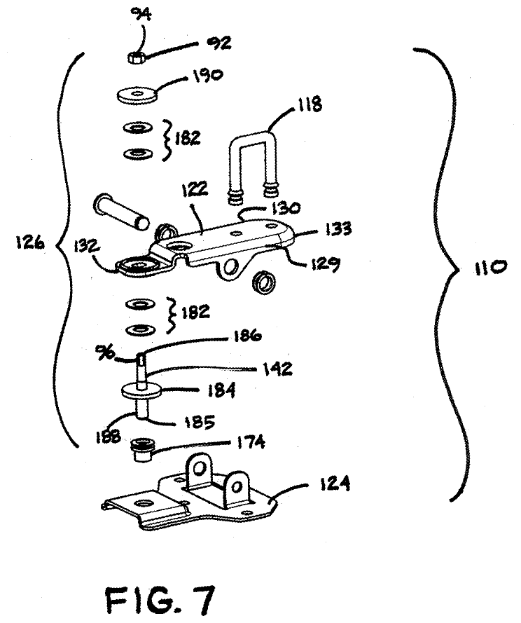

Referring now to FIGS. 6A-6F and FIG. 7, a striker assembly 110 constructed in accordance with another aspect of the disclosure is shown, wherein the same reference numerals, offset by a factor of 100, are used to identify like features. The striker assembly 110 includes a striker plate 122, with striker 118 fixed thereto, a base plate 124, and a dampener assembly 126. Striker assembly 100 is similar to striker assembly 10, with the notable difference pertaining to dampener assembly 126 being discussed hereafter, with all remaining features being the same or substantially the same, and thus, not being discussed in further detail.

The dampener assembly 126 includes a fixation member 142, wherein the fixation member 142 is configured to be fixed against movement relative to one of the striker plate 122 and the base plate 124, shown, by way of example and without limitation, as being fixed against relative movement to base plate 124. Dampener assembly 126 further includes at least one resilient dampener member 182 disposed about the fixation member 142 in fixed abutment with the other of the striker plate 122 and the base plate 124, shown, by way of example and without limitation, as being fixed against relative movement to striker plate 122 in abutment with striker plate 122. The at least one dampener member 182 is shown as a plurality of dampener members 182, provided and configured as discussed above.

The fixation member 142 has an annular flange 184 intermediate (between) opposite first and second ends 185, 186, wherein the first end 185 can be configured for fixed attachment to base plate 124, such as via external threads 188 configured for threaded engagement with internal threads 189 of rivet nut 174, as discussed above. With the first end 185 fixed to the rivet nut 174, the annular flange 184 can be located beneath a bottom side of the planar surface 128 with a shank of the fixation member 142 extending upwardly from the annular flange 184 above an upper side of the planar surface 128. To facilitate maintaining the dampener assembly 126 in an assembled state, a washer 190 can be disposed over the second end 186 in a clearance fit about the shank of the fixation member 142, and then, an adjustment member 92, such as a nut having internal threads 94, by way of example and without limitation, can be threaded into engagement with external threads 96 proximate the second end 186 to capture the washer 190 in fixed relation about the shank of the fixation member 142. While threading adjustment member 92 onto fixation member 142, an axial distance (distance extending axially along the length of the fixation member 142) can be precisely set between an upper surface of the annular flange 184 facing the striker plate 122 and a lower surface of the washer 190 facing the striker plate 122 to provide the desire compressive force between the dampener members 182 to establish a precisely predetermined preload across the dampener members 182.

Accordingly, it is to be recognized that the adjustment member 92 is selectively moveable along the fixation member 142 to change a dampening characteristic of the dampener member(s) 182, such as graphically depicted by an exemplary characteristic curve of FIG. 6G, illustrated by way of example and without limitation, with it to be recognized that the characteristic curve can be provided as desired. Adjustment of adjustment member 92 further provides an ability to adjust the position of striker 118 along the directions of arrow A, thereby allowing striker 118 to be optimally positioned during assembly.

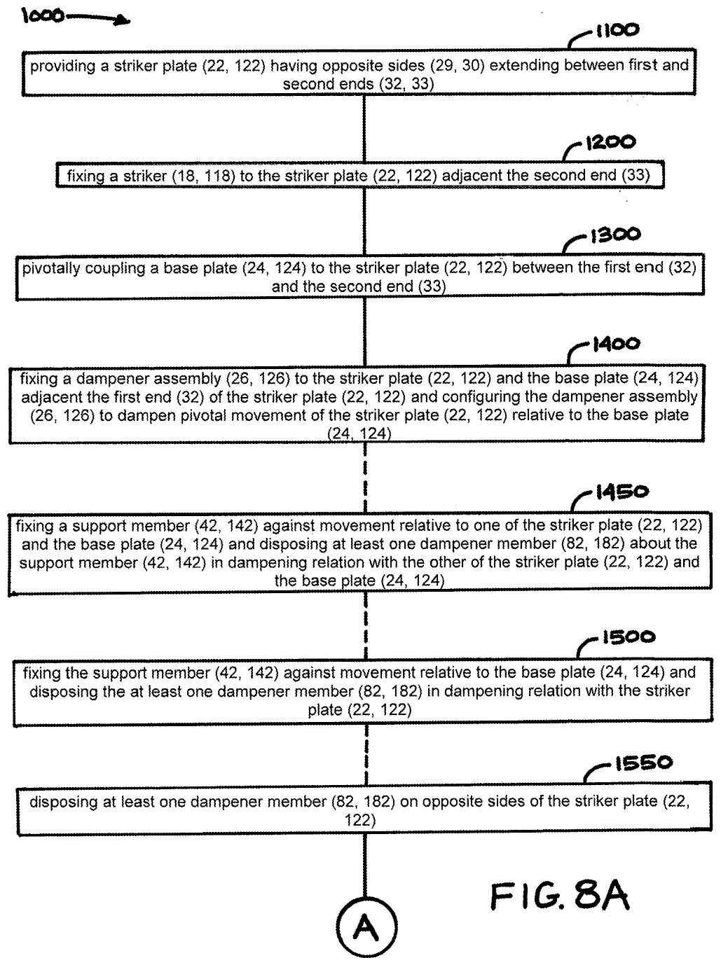

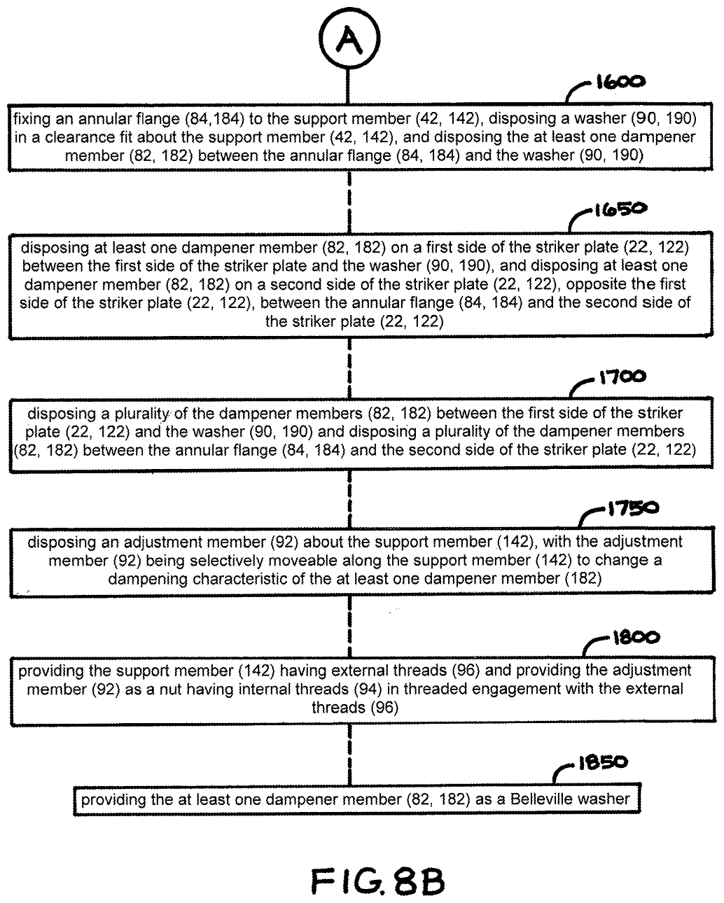

In accordance with another aspect of the disclosure, as diagrammed in FIG. 8, a method 1000 for inhibiting the generation and transmission of vibration through a striker assembly 10, 110 of a motor vehicle closure panel 19, 21 is provided. The method includes a step 1100 of providing a striker plate 22, 122 having opposite sides 29, 30; 129, 130 extending between first and second ends 32, 33; 132, 133. Further, a step 1200 of fixing a striker 18, 118 to the striker plate 22, 122 adjacent the second end 33, 133. Further, a step 1300 of pivotally coupling a base plate 24, 124 to the striker plate 22, 122 between the first end 32, 132 and the second end 33, 133. Further yet, a step 1400 of fixing a dampener assembly 26, 126 to the striker plate 22, 122 and the base plate 24, 124 adjacent the first end 32, 132 of the striker plate 22, 122 and configuring the dampener assembly 26, 126 to dampen pivotal movement of the striker plate 22, 122 relative to the base plate 24, 124.

In accordance with another aspect of the disclosure, the method 1000 can further include a step 1450 of fixing a support member 42, 142 against movement relative to one of the striker plate 22, 122 and the base plate 24, 124 and disposing at least one dampener member 82, 182 about the support member 42, 142 in dampening relation with the other of the striker plate 22, 122 and the base plate 24, 124.

In accordance with another aspect of the disclosure, the method 1000 can further include a step 1500 of fixing the support member 42, 142 against movement relative to the base plate 24, 124 and disposing the at least one dampener member 82, 182 in dampening relation with the striker plate 22, 122.

In accordance with another aspect of the disclosure, the method 1000 can further include a step 1550 of disposing at least one dampener member 82, 182 on opposite sides of the striker plate 22, 122.

In accordance with another aspect of the disclosure, the method 1000 can further include a step 1600 of fixing an annular flange 84, 184 to the support member 42, 142, disposing a washer 90, 190 in a clearance fit about the support member 42, 142, and disposing the at least one dampener member 82, 182 between the annular flange 84, 184 and the washer 90, 190.

In accordance with another aspect of the disclosure, the method 1000 can further include a step 1650 of disposing at least one dampener member 82, 182 on a first side of the striker plate 22, 122, facing away from the base plate 24, 124, between the first side of the striker plate 22, 122 and the washer 90, 190, and disposing at least one dampener member 82, 182 on a second side of the striker plate, opposite the first side of the striker plate and facing the base plate 24, 124, between the annular flange 84, 184 and the second side of the striker plate 22, 122.

In accordance with another aspect of the disclosure, the method 1000 can further include a step 1700 of disposing a plurality of dampener members 82, 182 between the first side of the striker plate 22, 122 and the washer 90, 190 and disposing a plurality of dampener members 82, 182 between the annular flange 84, 184 and the second side of the striker plate 22, 122.

In accordance with another aspect of the disclosure, the method 1000 can further include a step 1750 of disposing an adjustment member 92 about the support member 142 and moving the adjustment member 92 along the support member 142 to adjust a dampening characteristic of the at least one dampener member 182.

In accordance with another aspect of the disclosure, the method can further include a step 1800 of providing the support member 142 having external threads 96 and providing the adjustment member as a nut 92 having internal threads 94 in threaded engagement with the external threads 96.

In accordance with another aspect of the disclosure, the method 1000 can further include a step 1850 of providing the at least one dampener 82, 182 member as a Belleville washer.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A striker assembly for a vehicle closure panel, comprising:
a striker plate having opposite sides extending between first and second ends;
a striker fixed to said striker plate adjacent said second end;
a base plate pivotally coupled to said striker plate between said first end and said second end; and
a dampener assembly fixed to said striker plate and said base plate adjacent said first end of said striker plate, said dampener assembly dampening pivotal movement of said striker plate relative to said base plate.

2. The striker assembly of claim 1, wherein said dampener assembly includes a support member fixed against movement relative to one of said striker plate and said base plate and at least one dampener member disposed about said support member in dampening relation with the other of said striker plate and said base plate.

3. The striker assembly of claim 2, wherein support member is fixed against movement relative to said base plate and said at least one dampener member is disposed in dampening relation with said striker plate.

4. The striker assembly of claim 3, wherein said at least one dampener member includes at least one dampener member disposed on opposite sides of said striker plate.

5. The striker assembly of claim 2, further including an annular flange fixed to said support member and further including a washer disposed in a clearance fit about said support member wherein said at least one dampener member is disposed between said annular flange and said washer.

6. The striker assembly of claim 5, wherein said at least one dampener member includes a plurality of dampener members disposed between said annular flange and said washer, wherein at least one of said plurality of dampener members is disposed on a first side of said striker plate between said first side of said striker plate and said washer, and at least one of said plurality of dampener members is disposed on a second side of said striker plate, opposite said first side of said striker plate, between said annular flange and said second side of said striker plate.

7. The striker assembly of claim 6, wherein a plurality of said dampener members are disposed between said first side of said striker plate and said washer and a plurality of said dampener members are disposed between said annular flange and said second side of said striker plate.

8. The striker assembly of claim 2, further including an adjustment member disposed about said support member, said adjustment member being selectively moveable along said support member to change a dampening characteristic of said at least one dampener member.

9. The striker assembly of claim 8, wherein said support member has external threads and said adjustment member is a nut having internal threads in threaded engagement with said external threads.

10. The striker assembly of claim 2, wherein said at least one dampener member is a Belleville washer.

11. A method for inhibiting the generation and transmission of vibration through a striker assembly of a motor vehicle closure panel, comprising:
providing a striker plate having opposite sides extending between first and second ends;
fixing a striker to said striker plate adjacent said second end;
pivotally coupling a base plate to said striker plate between said first end and said second end; and
fixing a dampener assembly to said striker plate and said base plate adjacent said first end of said striker plate and configuring said dampener assembly to dampen pivotal movement of said striker plate relative to said base plate.

12. The method of claim 11, further including fixing a support member against movement relative to one of said striker plate and said base plate and disposing at least one dampener member about said support member in dampening relation with the other of said striker plate and said base plate.

13. The method of claim 12, further including fixing said support member against movement relative to said base plate and disposing said at least one dampener member in dampening relation with said striker plate.

14. The method of claim 13, further including disposing at least one dampener member on opposite sides of said striker plate.

15. The method of claim 12, further including fixing an annular flange to said support member, disposing a washer in a clearance fit about said support member, and disposing said at least one dampener member between said annular flange and said washer.

16. The method of claim 15, further including disposing at least one dampener member on a first side of said striker plate between said first side of said striker plate and said washer, and disposing at least one dampener member on a second side of said striker plate, opposite said first side of said striker plate, between said annular flange and said second side of said striker plate.

17. The method of claim 16, further including disposing a plurality of said dampener members between said first side of said striker plate and said washer and disposing a plurality of said dampener members between said annular flange and said second side of said striker plate.

18. The method of claim 12, further including disposing an adjustment member about said support member, with said adjustment member being selectively moveable along said support member to change a dampening characteristic of said at least one dampener member.

19. The method of claim 18, providing said support member having external threads and providing said adjustment member a nut having internal threads in threaded engagement with said external threads.

20. The method of claim 12, further including providing said at least one dampener member as a Belleville washer.
